(19) United States
(12) Patent Application Publication
(10) Pub. No.: US 2007/0223700 A1
(43) Pub. Date: Sep. 27, 2007

(54) CHAOTIC SIGNAL TRANSMITTER

(75) Inventors: Kwang Du LEE, JEONLANAM-DO (KR); Hyung Chul PARK, DAEJEON (KR); Chang Soo YANG, GYUNGGI-DO (KR)

Correspondence Address: LOWE HAUPTMAN BERNER, LLP, 1700 DIAGONAL ROAD, SUITE 300, ALEXANDRIA, VA, 22314, US

(73) Assignee: SAMSUNG ELECTRO-MECHANICS CO., LTD., GYUNGGI-DO (KR)

(21) Appl. No.: 11/689,940

(22) Filed: Mar. 22, 2007

(30) Foreign Application Priority Data
Mar. 24, 2006 (KR) 10-2006-0027153

(51) Int. Cl. H04L 9/00

(52) U.S. Cl. 380/263

(57) ABSTRACT

The invention relates to a chaotic transmitter which can precisely measure a distance between the transmitter and a receiver, thereby efficiently regulating transmission power according to the distance. The chaotic signal transmitter includes a chaotic signal generator for generating a chaotic signal and a quantizer for quantizing a transmission signal with a predetermined number of steps. The chaotic signal transmitter also includes a modulation controller for controlling the modulation of the chaotic signal according to the quantized transmission signal. The chaotic signal transmitter further includes a modulator for modulating the chaotic signal from the chaotic signal generator in a multiple OOK mode to output a plurality of chaotic signals and a combiner for combining the plurality of modulated chaotic signals.

### CLAIM OF PRIORITY

This application claims the benefit of Korean Patent Application No. 2006-0027153 filed on Mar. 24, 2006, in the Korean Intellectual Property Office, the disclosure of which is incorporated herein by reference.

### BACKGROUND OF THE INVENTION

1. Field of the Invention

The present invention relates to a chaotic signal transmitter and, more particularly, to a chaotic signal transmitter which can precisely measure a distance between the transmitter and a receiver using multiple On-Off Keying (OOK) modulation, thereby efficiently regulating transmission power according to the distance between the transmitter and the receiver.

2. Description of the Related Art

In general, a chaotic signal is characterized as an aperiodic signal with no particular phase, and a wide band signal. A typical periodic signal has a regular phase in accordance with time and thus may be distorted or cancelled when an interference signal of an antiphase is added. However, a chaotic signal has no clear phase so that it does not interfere with any antiphase signals or interference signals introduced thereto, thus protecting a data signal containing information. Also, in terms of frequency analysis, the chaotic signal has superior energy efficiency since it has a regulated magnitude irrespective of a period in a wide band.

Such a chaotic signal can be used as a carrier wave suitable for information transmission. This eliminates a need for a separate coding such as time hopping in a modem due to fewer spikes, allowing simple configuration of a transmitter or a receiver using a simple modulation method of On-Off Keying (OOK).

In the meantime, according to a conventional modulation method using the chaotic signal, a signal can be transmitted using a bandwidth of 10 to 20% of carrier frequency, in principle. But such a typical modulation method requires complex technical interpretation for the original signal during demodulation.

Despite such drawbacks, using the chaotic signal ensures controlled use through a small change in the system, thereby achieving a communication system with improved power efficiency. Moreover, the chaotic signal fundamentally has a continuous spectrum that expands into a wider frequency band, thus applicable to modulation without any loss of energy spectrum throughout the wide band. Therefore, with such merits, there have been attempts to apply a chaotic signal to a transmitter or a receiver that uses an ultra-wide band.

FIG. 1 is a block diagram illustrating a conventional chaotic signal transmitter.

Referring to FIG. 1, the conventional chaotic signal transmitter includes a chaotic signal generator 10 for generating a chaotic signal, a modulator 20 for modulating the chaotic signal from the chaotic signal generator 10 and an amplifier 30 for amplifying the chaotic signal modulated by the modulator 20.

The modulator 20 modulates the chaotic signal from the chaotic signal generator 10 in an OOK mode according to transmission data a user desires to transmit.

The amplifier 30 amplifies the chaotic signal modulated by the modulator 20 into a predetermined magnitude and transmits the amplified signal through an antenna.

The transmission data desired to be transmitted by the user is transformed into a transmission signal. The transmission signal uses a square wave in the form of a pulse. For example, in a case where the transmission signal is ‘101101’, and when ‘1’ is received, the modulator 20 switches ‘on’ the chaotic signal from the chaotic signal generator 10 so as to output the chaotic signal. When ‘0’ is received, the modulator switches ‘off’ the chaotic signal so as not to output the chaotic signal. This allows the chaotic signal to be modulated in an OOK mode in accordance with the transmission signal. The chaotic signal modulated according to the transmission signal is amplified by the amplifier 30 and transmitted. The reception result of the modulated chaotic signal by a receiver will now be explained with reference to FIG. 2.

FIG. 2 is a graph illustrating an example of a correlation result of a signal received from a conventional ultra-wide band transceiver using the chaotic signal.

Referring to FIG. 2, the graph represents the correlation result received by the receiver when the transmission signal is for example ‘101101’. The lowest point A of the graph represents ‘0’ and the highest point B of the graph represents ‘1’. In addition, C denotes a slope from the lowest point A to the highest point B. Since the transmission data is a square wave, the waveform received by the receiver composed of an envelope detector and the correlator is a triangle wave or a continuation of triangle waves.

In the meantime, in an ultra-wide band transmitter, the distance between a transmitter and a receiver is measured by correlating a signal transmitted from the transmitter at the receiver, sensing the time taken from the lowest point to the highest point from the correlation result, and transmitting the sensed time to the transmitter. From the correlation result of the received signal, the receiver determines the highest point according to the change in the slope from the lowest point to the highest point. Such distance measurement is an important factor directly related to efficiency in adjusting the power used in transmission according to the distance.

However, as shown in the graph of FIG. 2, in the conventional ultra-wide band transmitter, almost no change is exhibited in the slope C from the lowest point A to the highest point B, which makes it difficult to determine the highest point B. This in turn makes it difficult for the receiver to accurately sense the time taken from the lowest point A to the highest point B, hindering precise distance measurement. Therefore, since the distance between the transmitter and the receiver is not measured precisely, excessive transmission power is used to transmit the signal, degrading transmission power efficiency.

### SUMMARY OF THE INVENTION

The present invention has been made to solve the foregoing problems of the prior art and therefore an aspect of the present invention is to provide a chaotic signal transmitter which enables precise measurement of a distance between the transmitter and a receiver and.

Another aspect of the invention is to provide a chaotic signal transmitter which precisely measures a distance between the transmitter and a receiver to efficiently regulate transmission power.

According to an aspect of the invention, the invention provides a chaotic signal transmitter for enabling precise distance measurement from the transmitter to a receiver. The chaotic signal transmitter includes: a chaotic signal generator for generating a chaotic signal; a quantizer for quantizing a transmission signal with a predetermined number of steps; a modulation controller for outputting a modulation control signal to control modulation of the chaotic signal according to the transmission signal quantized by the quantizer; a modulator for modulating the chaotic signal from the chaotic signal generator in a multiple On-Off Keying (OOK) mode according to the modulation control signal of the modulation controller to output a plurality of modulated chaotic signals; and a combiner for combining the plurality of chaotic signals modulated by the modulator.

In addition, the chaotic signal transmitter according to the present invention further includes an amplifier for amplifying the chaotic signal from the combiner into a predetermined magnitude. Moreover, the chaotic signal transmitter further includes a filter for passing the combined chaotic signal from the combiner in a predetermined band to transfer the chaotic signal to the amplifier.

The quantizer may include a filter for passing only a low frequency component of the transmission signal.

The modulator includes a plurality of switches for switching on and off according to the modulation control signal of the modulation controller to modulate the chaotic signal in a multiple OOK mode.

The plurality of switches are adapted to switch on corresponding to ‘1’ in the modulation control signal so as to output the chaotic signal and switch off corresponding to ‘0’ in the modulation control signal so as not to output the chaotic signal.

The modulator further includes a plurality of amplifiers for amplifying the chaotic signals modulated by the plurality of switches into different predetermined magnitudes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram illustrating a conventional chaotic signal transmitter;

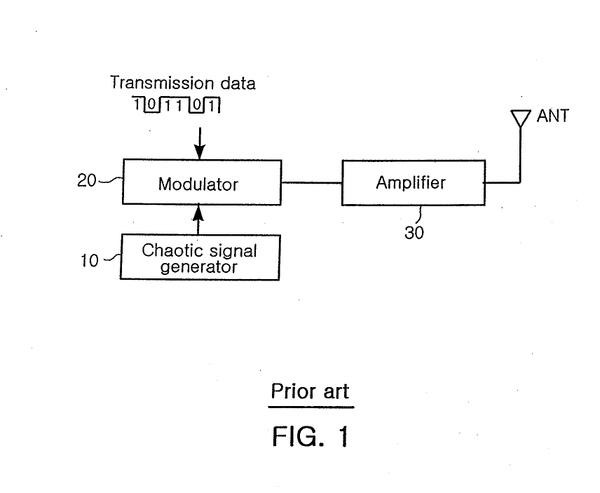

FIG. 2 is a graph illustrating an example of correlation result of a received chaotic signal, modulated by the conventional chaotic signal transmitter;

FIG. 3 is a block diagram illustrating a chaotic signal transmitter according to the present invention;

FIG. 4(a) to (e) is a graph illustrating an example of a signal modulation process of the chaotic signal transmitter according to the present invention; and

FIGS. 5(a) and (b) is a graph illustrating an example of correlation result of a received chaotic signal, modulated by the chaotic signal transmitter according to the present invention.

### DETAILED DESCRIPTION OF THE PREFERRED EMBODIMENT

Exemplary embodiments of the present invention will now be described in detail with reference to the accompanying drawings.

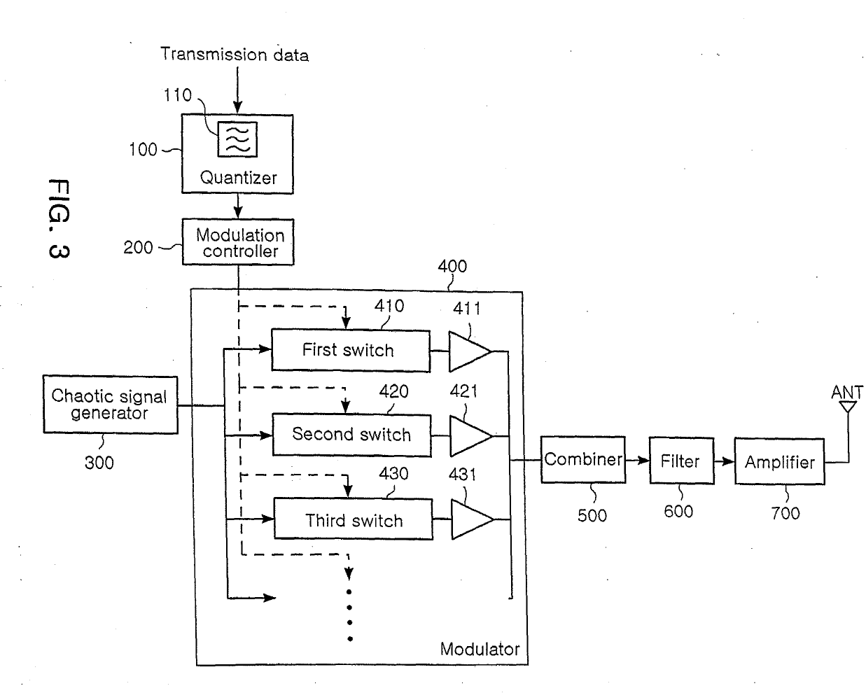

FIG. 3 is a block diagram illustrating a chaotic signal transmitter according to the present invention.

Referring to FIG. 3, the chaotic signal transmitter according to the present invention includes a quantizer 100 for quantizing a transmission signal; a modulation controller 200 for controlling modulation according to the quantized transmission signal from the quantizer 100; a chaotic signal generator 300 for generating a chaotic signal; a modulator 400 for modulating the chaotic signal in a multiple On-Off Keying (OOK) mode according to the control by the modulation controller 200; and a combiner 500 for combining the plurality of modulated chaotic signals from the modulator 400.

The quantizer 100 receives a transmission signal a user desires to transmit. Preferably, the transmission signal may be a square wave pulse. The transmission signal is of low frequency component passed through a filter 110 of the quantizer 100. The filter 110 is a pulse shaping filter for transforming the form of the transmission signal. The pulse shaping filter is a type of low pass filter which passes only the low frequency component of the transmission signal. The filtered transmission signal is quantized with a predetermined number of steps.

In a case where the transmission signal is a square wave, the transmission signal is of low frequency component passed through the filter 110 to have a form similar to a sine wave.

The transmission signal filtered to have a form similar to a sine wave is quantized with a predetermined number of steps. For example, the transmission signal may be quantized to have a total of 8 steps from 0 to 7.

The modulation controller 200 receives the quantized transmission signal and outputs a modulation control signal, which can control modulation of the signal according to the quantized transmission signal. That is, the modulation controller 200 outputs a modulation control signal made up of ‘0’ and ‘1’ according to the steps of the quantized transmission signal from the quantizer 100.

For example, if it is desired for the modulation controller 200 to control modulation of the chaotic signal according to the quantized transmission signal of 4 steps out of the transmission signal quantized with a total of 8 steps, as 4 is equivalent to a binary number of ‘100’, the modulation controller 200 outputs a modulation control signal of ‘100’ to control the signal modulation of the modulator 400.

The chaotic signal generator 300 generates a chaotic signal and supplies the chaotic signal to the modulator 400. The chaotic signal is a type of a noise signal having only energy but no particular phase. On the contrary, the transmission signal has only a magnitude but not energy needed for transmission. Therefore, the chaotic signal provides the transmission signal with an energy source needed for transmission. That is, the chaotic signal is modulated into a form identical to the transmission signal and transmitted. Modulation of the chaotic signal is conducted by the modulator 400.

The modulator 400 modulates the chaotic signal according to the modulation control signals. As described above, the modulation control signal is made up of ‘0’ and ‘1’. In addition, the modulator 400 includes a plurality of switches for switching on and off according to the modulation control signal to modulate the chaotic signal from the chaotic signal generator 300.

To be more specific, the modulator 400 includes a plurality of switches for switching on and off according to the modulation control signal of the modulation controller 200 such that the chaotic signal is modulated to exist in the same position as the quantized transmission signal or the chaotic signal is modulated not to exist in the same position as the quantized transmission signal. Thereby, the chaotic signal is modulated in a multiple OOK mode.

For example, if the transmission signal is quantized to have a total of 8 steps from 0 to 7, the modulation controller outputs 8 different modulation control signals, and 3 switches are needed for switching on and off.

As described in the above example, upon receiving the modulation control signal of ‘100’ from the modulation controller 200, a first switch 410 switches on while second and third switches switch off according to the modulation control signals.

The first switch 410 switches on so that the chaotic signal exists in the same position as the quantized transmission signal. On the contrary, the second and third switches 420 and 430 switch off so that the chaotic signal does not exist in the same position as the quantized transmission signal. Therefore, the switches 410, 420 and 430 modulate the chaotic signal in a multiple OOK mode according to the modulation control signal of the modulation controller 200.

In addition, amplifiers 411, 421 and 431 each having a different gain are connected respectively to the output ends of the switches 410, 420 and 430. The amplifiers 411, 421 and 431 amplify the chaotic signals outputted from the switches 410, 420 and 430 into different magnitudes.

For example, if a first amplifier 411 has a gain of 4, a second amplifier 421 has a gain of 2, and a third amplifier 431 has a gain of 1, the chaotic signals modulated by the modulation control signal of ‘100’ have a magnitude of 4.

The modulation controller 200 continuously outputs modulation control signals according to the quantized transmission signal, until the quantized transmission signal is terminated, and the modulator 400 outputs a plurality of chaotic signals modulated in a multiple OOK mode according to the modulation control signal.

The combiner 500 combines a plurality of chaotic signals modulated in a multiple OOK mode at the modulator 400. The combined chaotic signal has a form similar to that of the quantized transmission signal from the quantizer 100.

The ultra-wide band transmitter using chaotic signal according to the present invention may further include a filter 600 and an amplifier 700.

The filter 600 passes the signal of a predetermined band out of the chaotic signal from the combiner 500. The chaotic signal does not have one particular phase but has a plurality of phases mixed together to include various frequency components. The filter 600 passes the signal of a predetermined band out of the chaotic signal to provide a desired frequency band of chaotic signal.

The amplifier 700 amplifies the chaotic signal filtered by the filter 600 into a predetermined magnitude and transmits the amplified chaotic signal. The chaotic signal has a predetermined magnitude, which however gradually decreases with increase of the transmission distance as the signal is transmitted on the air. Therefore, the amplifier 700 amplifies the chaotic signal in a magnitude sufficient for transmission on the air through an antenna.

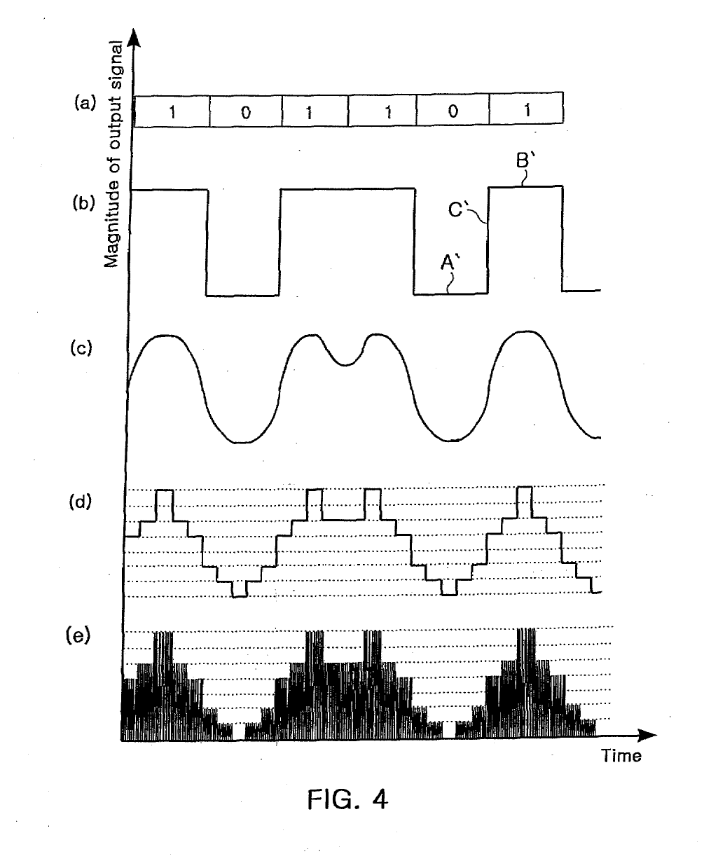

FIG. 4(a) to (e) is a graph illustrating an example of a process of signal modulation by the chaotic signal transmitter according to the present invention.

FIG. 4(a) shows the transmission data the user desires to transmit and FIG. 4(b) is the transmission signal transformed from the transmission data. The transmission signal is a square wave.

FIG. 4(c) shows the waveform of the transmission signal filtered through the filter 110 of the quantizer 100. The transmission signal is of low frequency component filtered through the filter 110 to have a form similar to a sine wave.

FIG. 4(d) shows the transmission signal quantized with a predetermined number of steps by the quantizer 100.

FIG. 4(e) shows the chaotic signal modulated in a multiple OOK mode by the modulator 400 and combined by the combiner 500.

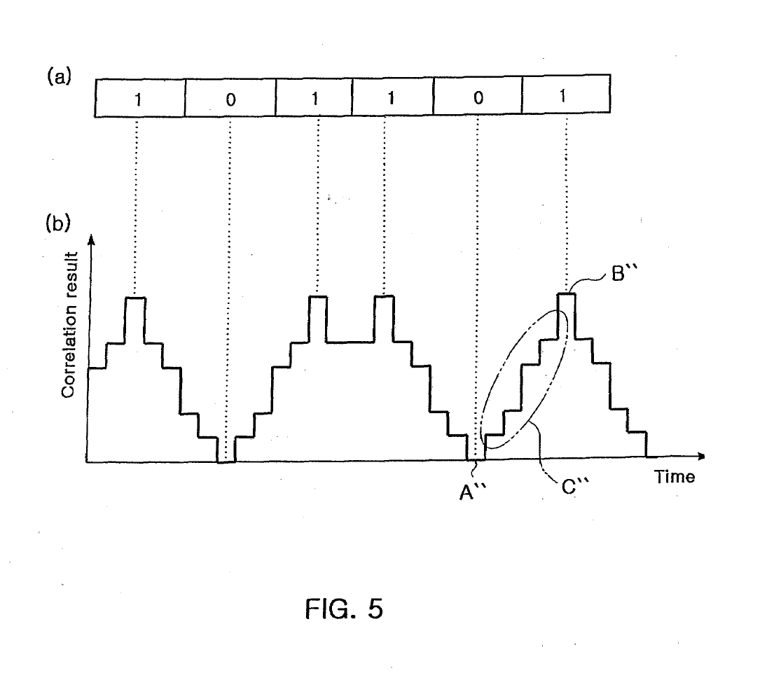

FIGS. 5(a) and (b) is a graph illustrating an example of correlation result of the received chaotic signal, modulated by the chaotic signal transmitter according to the present invention.

FIG. 5(a) represents the transmission data the user desires to transmit.

FIG. 5(b) represents the correlation result of the chaotic signal modulated by the chaotic signal transmitter according to the present invention and received by a receiver. Referring to FIG. 5(b), it can be seen that the transmission data desired by the user in FIG. 5(a) is accurately transmitted to the receiver. The correlation result is exhibited in accordance with time as the chaotic signal is received by the receiver and processed by an envelope detector and a correlator of the receiver.

Now, the operation and effects of the invention will be explained in detail with reference to accompanying drawings.

Referring to FIGS. 3 and 4(a) to (e), the transmission signal the user desires to transmit is received by the quantizer 100. For example, if the transmission data is ‘101101’ as shown in FIG. 4(a), the transmission signal is a signal of a square wave as shown in FIG. 4(b).

The transmission signal of a square wave is of low frequency component passed through the filter 110 of the quantizer 100. Referring to FIG. 4(c), the transmission signal received by the quantizer 100 is of low frequency component passed and has similar linearity as a sine wave.

The transmission signal having such linearity is quantized with a predetermined number of steps through the quantizer 100. FIG. 4(d) shows the quantized transmission signal. Referring to FIG. 4(d), the transmission signal with the above linearity is quantized with a total of 8 steps from 0 to 7. The modulation controller 200 outputs the modulation control signals in the form of a binary number according to the steps of the quantized transmission signal.

For example, if the transmission signal is quantized with 6 steps out of the total of 8 steps, the modulation controller 200 outputs a modulation control signal of ‘110’ according to the quantized transmission signal of the 6 steps. In accordance with the modulation control signal of ‘110’ from the modulation controller, the modulator 400 switches on the first and second switches 410 and 420 so as to output the chaotic signals from the chaotic signal generator 300, and switches off the third switch 430 so as not to output the chaotic signal. The chaotic signals are amplified into different magnitudes and outputted through the amplifiers 411, 421 and 431 each having a different gain.

Referring to FIG. 4(e), the combiner 500 combines the plurality of chaotic signals modulated according to the modulation control signal of the modulation controller 200. For example, if the first amplifier 411 has a gain of 4, the second amplifier 421 has a gain of 2, and the third amplifier 431 has a gain of 1, the combined chaotic signal has a magnitude the same as the transmission signal quantized into the 6 steps. Then, as mentioned above, the plurality of chaotic signals modulated according to the continuous modulation control signals are combined by the combiner 500.

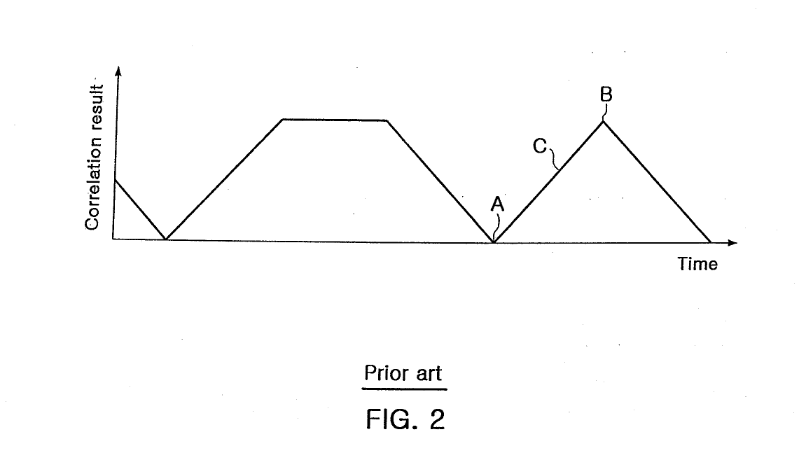

Referring to FIGS. 2 to 5(a) and (b), A′ and B′ in FIG. 4(b) denote the highest point A′ and the lowest point B′, respectively, of the transmission signal received by the quantizer 100, and C′ denotes the change rate of the slope for the section from the lowest point A′ to the highest point B′.

In FIG. 4(b), it can be seen that no change is exhibited in the slope denoted by C′ for the section leading to the highest point B′.

The chaotic signal transmitter according to the present invention quantizes the transmission signal to modulate the chaotic signal according to the quantized transmission signal, thereby transmitting the chaotic signal to the receiver. The correlation result of the chaotic signal transmitted to the receiver is as shown in FIG. 5(b).

C″ in FIG. 5(b) denotes the slope of the section from the lowest point A″ to the highest point B″. As the transmission signal is quantized and the chaotic signal is modulated in a multiple OOK mode in accordance with the quantized transmission signal, the slope C″ of the section leading to the highest point B″ exhibits change rates. That is the slope C″ changes gradually.

When compared with FIG. 2, the slope C of the section from the lowest point A to the highest point B of the chaotic signal modulated by the conventional transmitter is a straight line, whereas the slope C″ leading to the highest point B″ of the chaotic signal modulated by the transmitter according to the present invention exhibits various changes. This allows accurate determination of the highest point according to the change rates of the slope of the chaotic signal modulated by the receiver. Thereby, the time taken from the lowest point to the highest point is accurately sensed, enabling precise distance measurement between the transmitter and the receiver.

According to the present invention as set forth above, multiple OOK modulation is adopted to vary the change rate of the slope of the section leading to the highest point of the chaotic signal, enabling precise distance measurement between a transmitter and a receiver. Precise measurement of distance between the transmitter and the receiver allows using only an amount of power necessary for signal transmission, resulting in efficient regulation of the transmission power.

While the present invention has been shown and described in connection with the exemplary embodiments, it will be apparent to those skilled in the art that modifications and variations can be made without departing from the spirit and scope of the invention as defined by the appended claims.

What is claimed is:

1. A chaotic signal transmitter for enabling precise distance measurement from a receiver to the transmitter, comprising:
a chaotic signal generator for generating a chaotic signal;
a quantizer for quantizing a transmission signal with a predetermined number steps;
a modulation controller for outputting a modulation control signal to control modulation of the chaotic signal according to the transmission signal quantized by the quantizer;
a modulator for modulating the chaotic signal from the chaotic signal generator in a multiple On-Off Keying (OOK) mode according to the modulation control signal of the modulation controller to output a plurality of modulated chaotic signals; and
a combiner for combining the plurality of chaotic signals modulated by the modulator.

2. The chaotic signal transmitter according to claim 1, further comprising an amplifier for amplifying the chaotic signal from the combiner into a predetermined magnitude.

3. The chaotic signal transmitter according to claim 2, further comprising a filter for passing the combined chaotic signal from the combiner in a predetermined band to transfer the chaotic signal to the amplifier.

4. The chaotic signal transmitter according to claim 1, wherein the quantizer comprises a filter for passing only a low frequency component of the transmission signal.

5. The chaotic signal transmitter according to claim 1, wherein the modulator comprises a plurality of switches for switching on and off according to the modulation control signal of the modulation controller to modulate the chaotic signal in a multiple OOK mode.

6. The chaotic signal transmitter according to claim 5, wherein the plurality of switches are adapted to switch on corresponding to ‘1’ in the modulation control signal of so as to output the chaotic signal and switch off corresponding to ‘0’ in the modulation control signal so as not to output the chaotic signal.

7. The chaotic signal transmitter according to claim 5, wherein the modulator further comprises a plurality of amplifiers for amplifying the chaotic signals modulated by the plurality of switches into different predetermined magnitudes.
